(19) United States
(12) Patent Application Publication
(10) Pub. No.: US 2026/0136023 A1
(43) Pub. Date: May 14, 2026

(54) METHODS AND APPARATUSES FOR PADDING REFERENCE SAMPLES

(71) Applicant: InterDigital CE Patent Holdings, SAS, Paris (FR)

(72) Inventors: Philippe Bordes, Laille (FR); Thierry Dumas, Rennes (FR); Kevin Reuze, Rennes (FR); Karam Naser, Mouaze (FR)

(21) Appl. No.: 19/122,333

(22) PCT Filed: Oct. 3, 2023
(86) PCT No.: PCT/EP2023/077348

§ 371 Date: Apr. 18, 2025

(30) Foreign Application Priority Data
Oct. 21, 2022 (EP) 22306598.8

(51) Int. Cl. H04N 19/176; H04N 19/105; H04N 19/159; H04N 19/513; H04N 19/563

(52) U.S. Cl. CPC H04N 19/176; H04N 19/105; H04N 19/159; H04N 19/513; H04N 19/563

(57) ABSTRACT

A method and an apparatus for encoding or decoding a video wherein for at least one first block to encode or decode, at least one reference sample is determined based on a coding mode used for reconstructing at least one second block. For instance, intrapadding or motion-compensation of a third block to which the at least one reference sample belong is performed using coding data of the at least one second block. A prediction is then obtained for the at least one first block using the at least one reference sample, and the at least one first block is encoded or decoded based on the prediction.

This application claims the priority to European Application No. 22306598.8, filed 21 Oct. 2022, which is incorporated herein by reference in its entirety.

### TECHNICAL FIELD

The present embodiments generally relate to video compression. The present embodiments relate to a method and an apparatus for encoding or decoding an image or a video. More particularly, the present embodiments relate to reference samples determination and image or video block prediction.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to an aspect, a method for encoding an image or a video is provided. The method comprises determining at least one reference sample for at least one first block of an image, based on a coding mode used for reconstructing at least one second block of the image, obtaining a prediction for the at least one first block using the at least one reference sample, encoding the at least one first block based on the prediction. The at least one reference sample belongs to a third block in a reference area of the at least one first block, and distinct from the at least one second block.

According to another aspect, an apparatus for encoding an image or a video is provided. The apparatus comprises one or more processors operable to determine at least one reference sample for at least one first block of an image, based on a coding mode used for reconstructing at least one second block of the image, obtain a prediction for the at least one first block using the at least one reference sample, encode the at least one first block based on the prediction. The at least one reference sample belongs to a third block in a reference area of the at least one first block, and distinct from the at least one second block.

According to another aspect, a method for decoding an image or a video is provided. The method comprises determining at least one reference sample for at least one first block of an image, based on a coding mode used for reconstructing at least one second block of the image, obtaining a prediction for the at least one first block using the at least one reference sample, decoding the at least one first block based on the prediction. The at least one reference sample belongs to a third block in a reference area of the at least one first block, and distinct from the at least one second block.

According to another aspect, an apparatus for decoding an image or a video is provided. The apparatus comprises one or more processors operable to determine at least one reference sample for at least one first block of an image, based on a coding mode used for reconstructing at least one second block of the image, obtain a prediction for the at least one first block using the at least one reference sample, decode the at least one first block based on the prediction. The at least one reference sample belongs to a third block in a reference area of the at least one first block, and distinct from the at least one second block.

Further embodiments that can be used alone or in combination are described herein.

In some embodiments, the at least one reference sample belongs to a non-reconstructed block or to a block having a coding mode that is not allowed for determining a prediction for the at least one first block using the at least one reference sample.

In some embodiments, the at least one second block is coded using intra prediction. In other embodiments, the at least one second block is coded using inter-prediction.

In some embodiments, the first block is predicted using intra-prediction. In other embodiments, the first block is predicted using inter-prediction.

In some embodiments, the first block is predicted using additional intra prediction directions using reference samples determined in a right and or bottom block of the first block. In other words, the first block is predicted using reference samples from a non-causal area of the first block, that is an area that is not yet reconstructed when encoding/decoding the first block.

One or more embodiments also provide a computer program comprising instructions which when executed by one or more processors cause the one or more processors to perform the method for encoding or decoding an image or a video according to any of the embodiments described herein. One or more of the present embodiments also provide a non-transitory computer readable medium and/or a computer readable storage medium having stored thereon instructions for encoding or decoding an image or a video according to the methods described herein.

One or more embodiments also provide a computer readable storage medium having stored thereon a bitstream generated according to the methods described herein. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder within which aspects of the present embodiments may be implemented.

FIG. 3 illustrates a block diagram of an embodiment of a video decoder within which aspects of the present embodiments may be implemented.

FIG. 4 illustrates an example of a padding area of a reference picture.

FIG. 5 illustrates an example of a motion-compensated padding of a padding area.

FIG. 6 illustrates an example of reference samples for intra prediction. The pixel values at coordinates (x,y) are indicated in the figure by P(x,y) relatively to a current block which starts at (0,0).

FIG. 7 illustrates an example of reference sample substitution for intra prediction.

FIG. 8 illustrates an example of a method of reference sample substitution for intra prediction.

FIG. 9 shows examples of intra prediction directions: on the left intra prediction directions in HEVC (the number denotes the prediction mode index associated with the corresponding directions. The modes 2 to 17 indicate horizontal directions H−26 to H+32) and the modes 18 to 34 indicate vertical directions V−32 to V+32, on the right intra prediction directions in VVC.

FIG. 10 shows examples of wide-angle intra predictions.

FIG. 11 shows an example of a planar mode intra prediction.

FIG. 12 illustrates an example of inter-prediction mode using reconstructed reference samples.

FIG. 13 illustrates an example of a method for encoding a block of an image or a video according to an embodiment.

FIG. 14 illustrates an example of a method for decoding a block of an image or a video according to an embodiment.

FIG. 15 illustrates an example of reference sample substitution using MC-padding according to an embodiment.

FIG. 16 illustrates an example of a method for intra prediction using MC-padding for filling missing reference samples, according to an embodiment.

FIG. 17 illustrates an example of reference sample substitution using MC-padding with above-right reconstructed block coded in inter and mrlIdx>0, according to an embodiment.

FIG. 18 illustrates an example of unavailable reference samples substituted with MC of reference block extension according to an embodiment.

FIG. 19 illustrates an example of reference samples substitution using intra-padding with above reconstructed block coded in intra according to an embodiment.

FIG. 20 illustrates an example of intra-padding applied to picture padding according to an embodiment.

FIG. 21 illustrates an example of reference samples estimation for intra prediction according to an embodiment.

FIG. 22 illustrates an example of a method for intra prediction according to an embodiment.

FIG. 23 illustrates an example of intra prediction angles for intra prediction.

FIG. 24 illustrates an example of a method for intra prediction.

FIGS. 25A, 25B and 25C illustrate examples of reference samples for intra prediction substitution according to an embodiment.

FIG. 26 illustrates an example of a method for encoding a block of an image or a video according to an embodiment.

FIG. 27 illustrates an example of a method for decoding a block of an image or a video according to an embodiment.

FIG. 28 illustrates a block diagram of a system within which aspects of the present embodiments may be implemented, according to another embodiment.

FIG. 29 shows two remote devices communicating over a communication network in accordance with an example of the present principles.

FIG. 30 shows the syntax of a signal in accordance with an example of the present principles.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

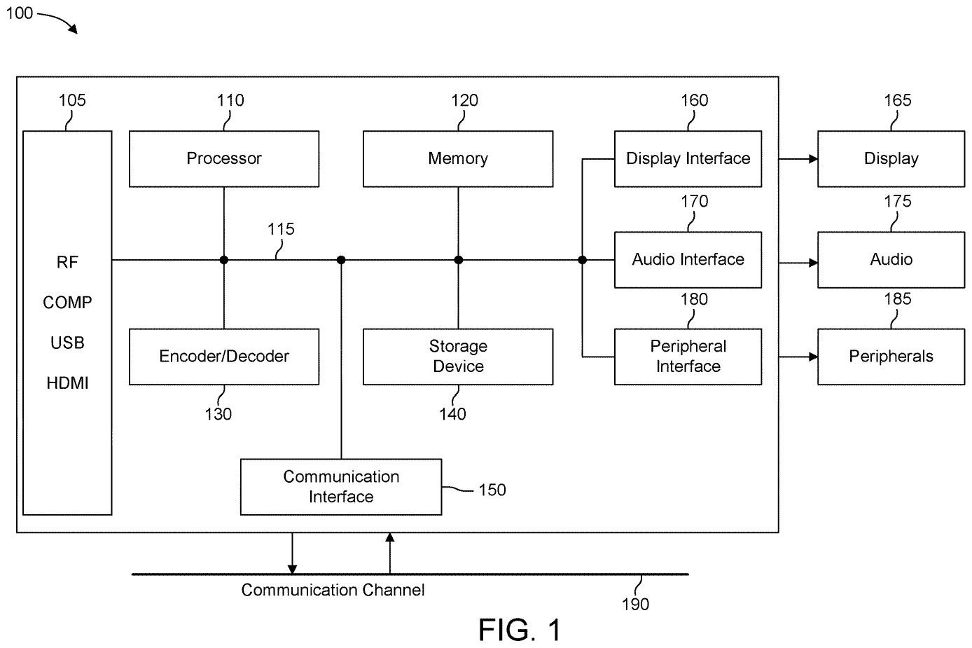

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

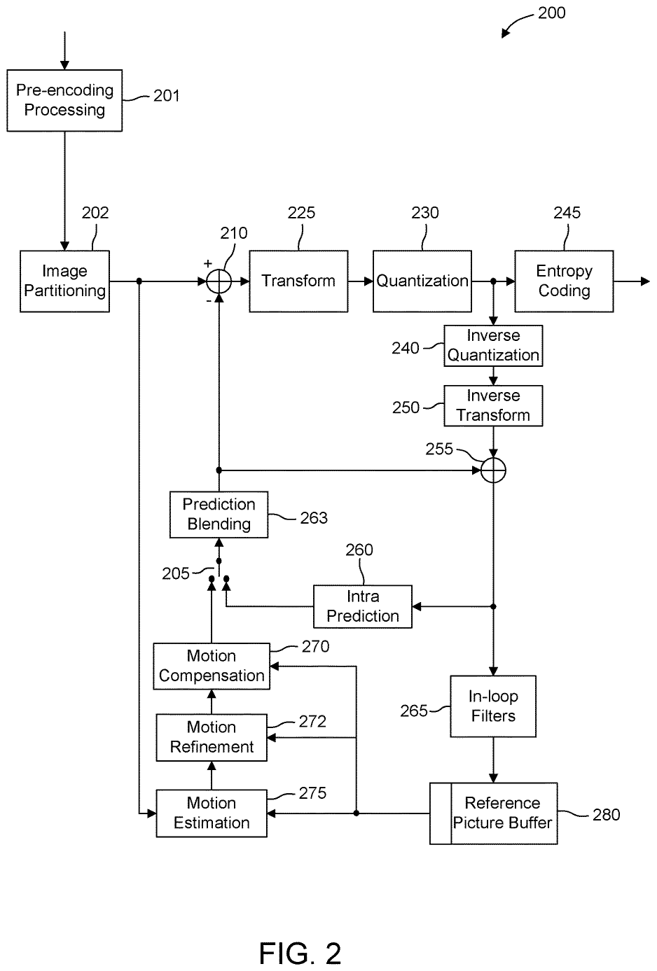

FIG. 2 illustrates an encoder 200. Variations of this encoder 200 are contemplated, but the encoder 200 is described below for purposes of clarity without describing all expected variations.

In some embodiments, FIG. 2 also illustrate an encoder in which improvements are made to the HEVC standard or a VVC standard or an encoder employing technologies similar to HEVC or VVC, such as an encoder ECM under development by JVET (Joint Video Exploration Team). Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of color components), or re-sizing the picture (ex: down-scaling). Metadata can be associated with the pre-processing, and attached to the bitstream.

In the encoder 200, a picture is encoded by the encoder elements as described below. The picture to be encoded is partitioned (202) and processed in units of, for example, CUs (Coding units) or blocks. In the disclosure, different expressions may be used to refer to such a unit or block resulting from a partitioning of the picture. Such wording may be coding unit or CU, coding block or CB, luminance CB, or block . . . A CTU (Coding Tree Unit) may refer to a group of blocks or group of units. In some embodiments, a CTU may be considered as a block, or a unit as itself.

Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods. Prediction residuals are calculated, for example, by subtracting (210) the predicted block from the original image block.

The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

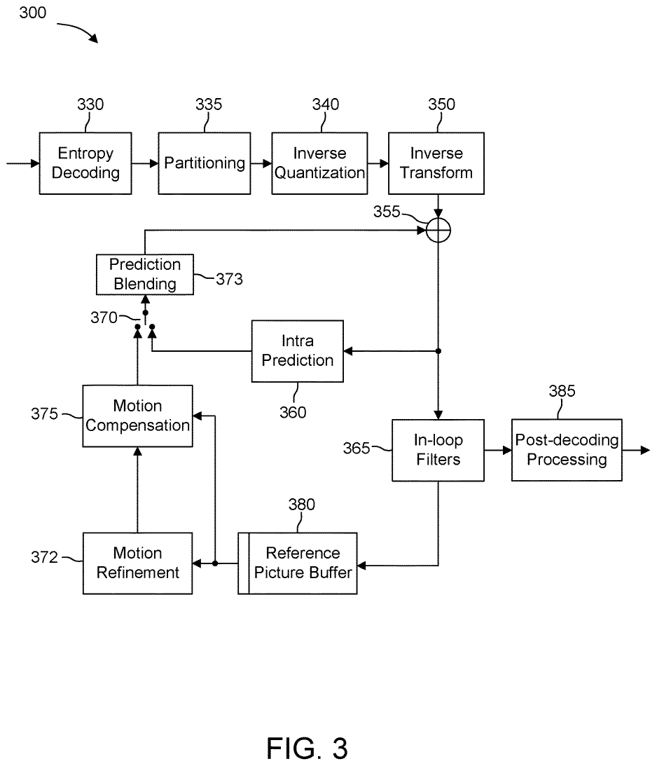

FIG. 3 illustrates a block diagram of a video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201), or re-sizing the reconstructed pictures (ex: up-scaling). The post-decoding processing can use metadata derived in the pre-encoding processing and signaled in the bitstream.

Some of the embodiments described herein relate to improving the padding of reference samples of a block of an image or video to encode or decode.

### Reference Picture Boundary Padding

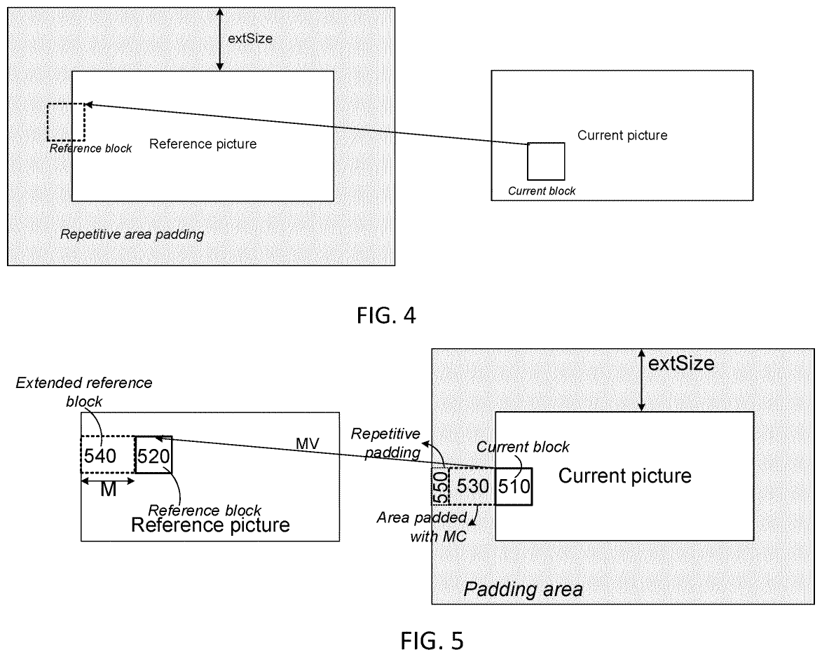

In traditional video codecs, during the process of reconstructing the picture furtherly used as reference picture, an extended picture area is built with an area surrounding the picture width/height of size of “extSize” columns/lines, as depicted in FIG. 4. The samples in the extended area are derived by repetitive boundary padding. In inter prediction, when a reference block locates partially or completely out of the picture boundary (OOB), the repetitive padded pixel is used for motion compensation (MC). In this way, the reference block may be partly situated out of the reconstructed reference picture, as depicted in FIG. 4, and/or the motion vector is not clipped so that the reference block is entirely included in the reference picture. This feature allows increasing the coding efficiency.

### Motion Compensated Picture Boundary Padding (MC-Padding)

Advantageously, as illustrated in FIG. 5, it has been proposed replacing the repetitive padding for the area (530) situated close to the current block (510) coded in inter, using motion compensation and extending (540) the reference block (520) with M columns or lines. The motion compensation uses the same motion vector(s) MV as for reconstructing the current block, as depicted in FIG. 5 for uni-directional prediction. If M is inferior to extSize, the area far from the current picture boundary (550) is padded with repetitive padding. If the current block (510) is intra coded, then MV is not available, and M is set equal to 0.

### Intra Prediction and Reference Samples Substitution

The intra prediction process in HEVC and VVC consists of three steps:
Reference sample generation
Intra sample prediction and
Post-processing of predicted samples.

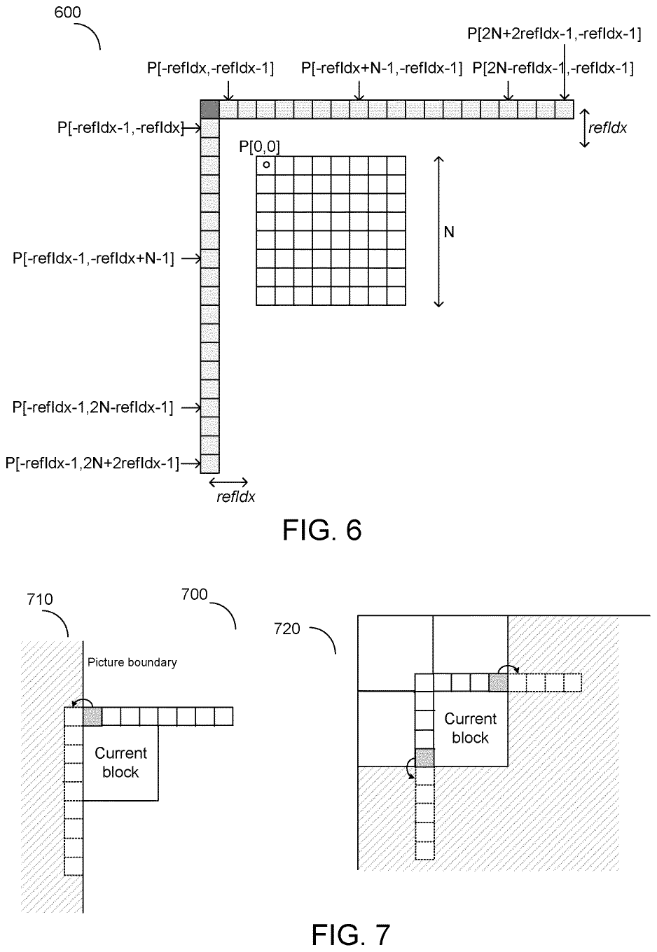

The reference sample generation process is illustrated in FIG. 6. The reference samples ref[ ] are also known as L-shape. For a prediction unit (PU) of size N×N, a row of (2N+2refIdx) decoded samples on the top is formed from the previously reconstructed top and top right pixels to the current PU. Similarly, a column of (2N+2refIdx) samples on the left is formed from the reconstructed left and below left pixels. In VVC, the reference line and column of samples may be distant (d=refIdx) of more than one sample to the current block as depicted in FIG. 6 (600). An index “mrlIdx” is signaled to indicate which value of “d” should be used.

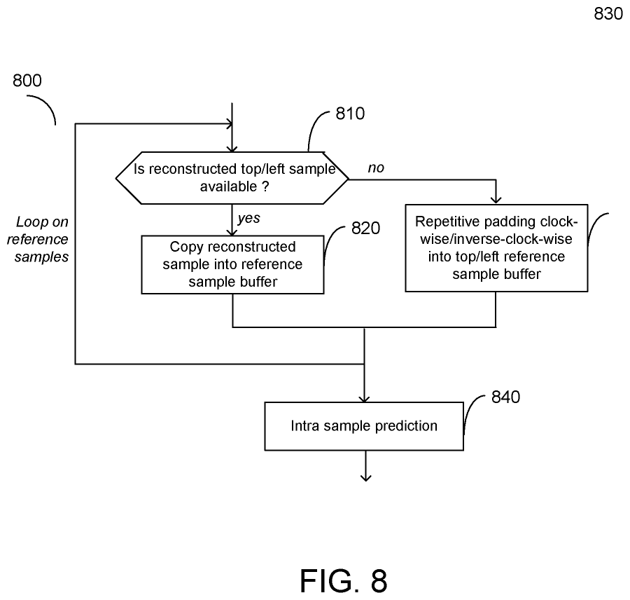

FIG. 8 illustrates an example of a method (800) for reference sample generation. The corner pixel at the top-left position is also used to fill up the gap between the top row and the left column references. If some of the samples on top or left are not available (810), because for example of the corresponding CUs not being in the same slice, or the current CU being at a frame boundary (710 on FIG. 7), or the current CU being at the bottom-right after a quadtree split (720 on FIG. 7) for example, then a method called reference sample substitution is performed where the missing samples are copied from the available samples in a clock-wise and inverse clock-wise direction (700 on FIG. 7, 830 on FIG. 8). In FIG. 7, the dashed area corresponds to the region of the picture not yet reconstructed and the missing reference samples are in dot-line. At 820, when the top or left samples are available, the reconstructed samples are copied into the reference sample buffer.

Next, depending on the current CU size and the prediction mode, the reference samples can be filtered using a specified filter.

The intra sample prediction consists of predicting the pixels of the target CU based on the reference samples. There exist different prediction modes: Planar and DC prediction modes are used to predict smooth and gradually changing regions, whereas angular (angle defined from 45 degrees to −135 degrees in clockwise direction) prediction modes are used to capture different directional structures. For square blocks, HEVC supports 33 directional prediction modes which are indexed from 2 to 34. These prediction modes correspond to different prediction directions as illustrated in FIG. 9 left. In VVC, there are 65 angular prediction modes, corresponding to the 33 angular directions defined in HEVC, and further 32 directions each corresponding to a direction mid-way between an adjacent pair (FIG. 9 right).

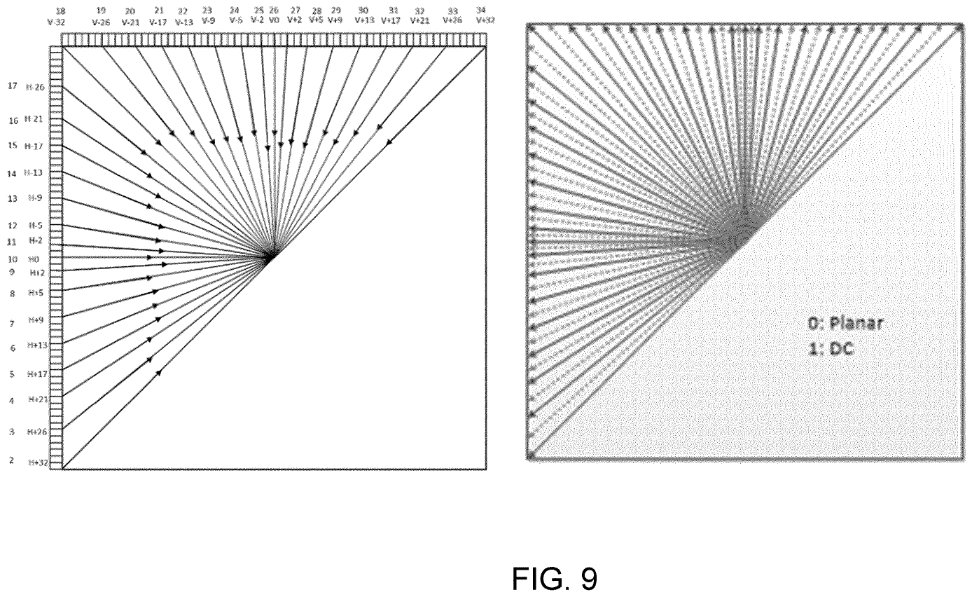

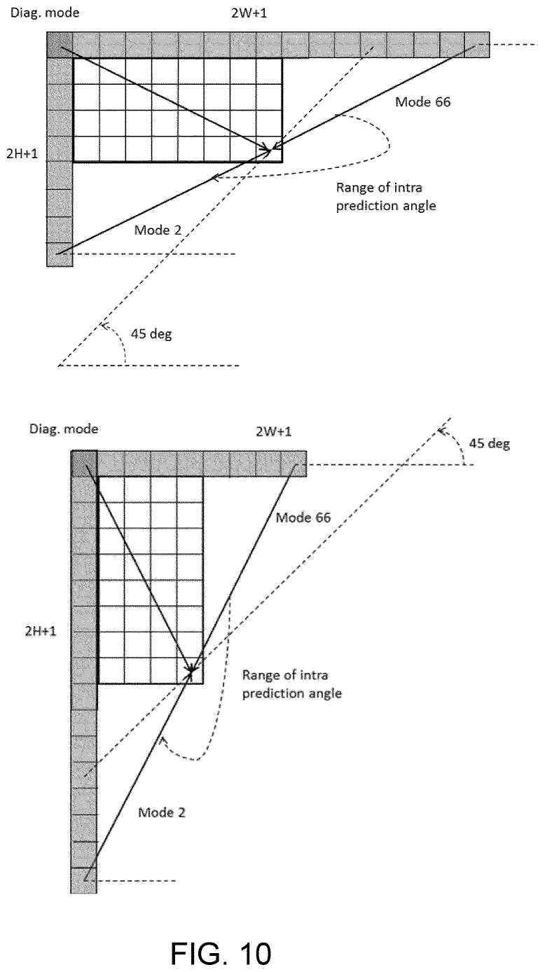

In VVC, for non-square blocks, the regular directional intra prediction which are not allowed (see FIG. 10) are replaced with additional wide-angle intra prediction modes.

For a given angular prediction mode, the predictor samples on the reference arrays are copied along the corresponding direction inside the target PU. Some predictor samples may have integral locations, in which case they match with the corresponding reference samples; the location of other predictors will have fractional parts indicating that their locations will fall between two reference samples. In the latter case, the predictor samples are interpolated using the nearest reference samples (post-processing of predicted samples). In HEVC, a linear interpolation of the two nearest reference samples is performed to compute the predictor sample value; In VVC, for interpolating the predictor samples, 4-tap filters fT[ ] are used which are selected depending on the intra mode direction.

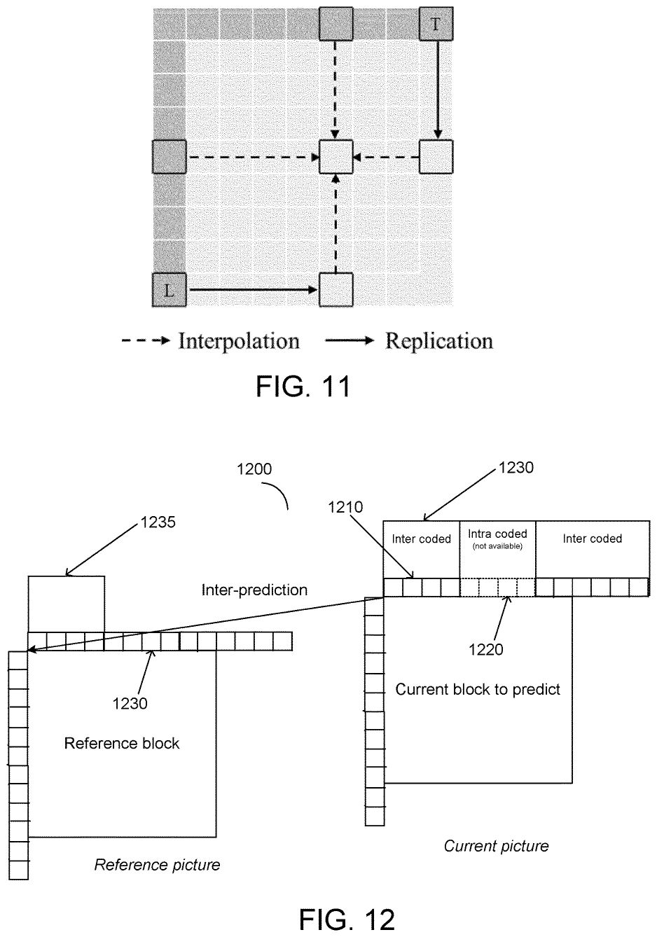

Besides directional modes, the DC mode fills-in the prediction with the average of the samples in the L-shape (except for rectangular CUs that use average of reference samples of the longer side), and the Planar mode interpolate reference samples spatially as depicted in FIG. 11.

### Other Prediction Modes Using Reconstructed Reference Samples Substitution

There exist other coding modes where the block prediction is based on reconstructed reference samples situated in the neighboring template. For example, the local illumination compensation (LIC) derives illumination compensation model to correct the inter prediction samples with linear model:

$${P}^{′} ( x ) = a \cdot P ( x ) + b$$

Where P′ is the corrected prediction, P is the inter-prediction, x is the sample position and (a,b) are the illumination compensation parameters (LIC model). The LIC model parameters are derived with some reconstructed samples neighboring to the current block (1210) in the current picture and the co-located neighboring samples to the reference block in the reference picture (1235), as depicted in FIG. 12. However, some reconstructed reference samples in the current picture may be unavailable since additional conditions have restricted (forbidden) access to some reconstructed samples (1220) in the current picture for implementation complexity reduction purpose (memory access, number of pipelined operations per block to reconstruct, etc. . . . ). For example, such limitation may be to not access the reconstructed samples of neighboring blocks coded in intra for reconstructing a current block coded in inter mode. In these cases, reference sample substitution such as repetitive padding should be applied in place.

The MC-padding method described above allows for improving the padding for pictures (or blocks) coded in inter, however the intra pictures (or blocks) are still using repetitive padding since no reference block can be extended using inter-prediction parameters.

In intra prediction, and some other modes that use reference samples substitution, the reference sample substitution process as described above allows coping with missing reconstructed samples availability, but at the expense of reduced coding efficiency since simple repetition is made.

In some embodiments, the reference sample substitution process (also known as padding of reference samples) of the intra-prediction or inter-prediction is modified by replacing repetitive padding with motion-compensated or intra sample prediction padding technique.

The embodiments described herein can be applied for any other coding mode where the prediction uses neighboring reconstructed reference samples.

In some embodiments, the reference picture boundary padding is improved for the case of samples at boundary of intra coded blocks.

In other embodiments, the reference sample substitution is extended to improve the intra prediction process, such as the one known from HEVC or VVC, with estimated reference samples that are closer to the actual current CU boundary.

Any one of the embodiments described herein can be implemented for instance in an intra prediction module 260 or motion estimation 275, motion refinement 272 or motion compensation 270 of the image or video encoder 200 or in an intra prediction module 360 or motion refinement 372 or motion compensation 375 of the image or video decoder 300.

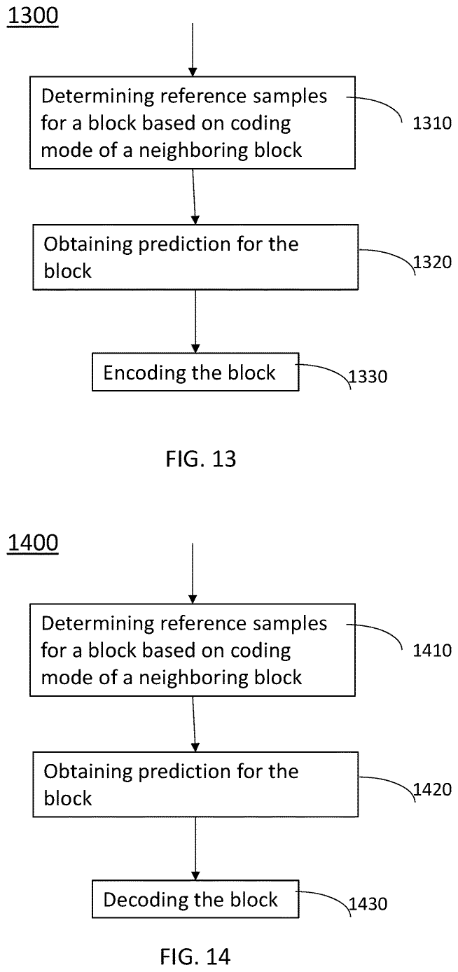

FIG. 13 illustrates an example of a method 1300 for encoding a block of an image or a video according to an embodiment. At 1310, one or more reference samples belonging to a reference area for a block of an image to encode are determined. The reference area is for instance the L-shape on top and left of the block to encode as illustrated in any one of the FIG. 4-5, 6-7, 10-12.

The one or more reference samples are determined based on a coding mode that is used for reconstructing one or more second blocks of the image. The one or more reference samples that are determined are not part of the one or more second blocks, i.e they are located outside of the one or more second blocks. In some embodiments, the one or more reference samples belong to a block that has not yet been reconstructed when the block to encode is processed for encoding. In other embodiments, the one or more reference samples belong to a block that has a coding mode that is not allowed for being used when predicting the block to encode using a given coding mode. For instance, the one or more reference samples belong to a block that is intra-coded, while the block to encode is to be encoded using an inter-prediction coding mode using a LIC tool, in that case, as discussed above, intra-coded block cannot be used for determining the LIC parameters. And depending on the encoder/decoder implementation, the intra-coded blocks in an inter-frame are not even yet reconstructed when the current block is processed for inter prediction.

In some variants, the one or more reference sample belong to a block neighboring the one or more second blocks. Depending on the variants described further below, the one or more second blocks have been reconstructed using an inter-prediction mode or using an intra-prediction mode.

When the one or more second blocks are encoded using an inter-prediction mode, the one or more reference samples are filled with motion-compensated data that is obtained using motion information of the one or more second block.

When the one or more second blocks are encoded using an intra-prediction mode, the one or more reference samples are filled with data that is obtained using a same intra prediction mode as the one used for the one or more second blocks.

Once the one or more reference samples have been determined, at 1320, a prediction is obtained for the block to encode using one or more reference samples, and at 1330, the block is encoded using the prediction.

FIG. 14 illustrates an example of a method 1400 for decoding a block of an image or a video according to an embodiment. At 1410, one or more reference samples belonging to a reference area for a block of an image to decode are determined in a similar manner as in 1310 of FIG. 13. Once the one or more reference samples have been determined, at 1420, a prediction is obtained for the block to decode using one or more reference samples, and at 1430, the block is decoded using the prediction.

Some variants of the embodiments mentioned above are further described below.

Reference Sample Substitution for Intra Prediction with Neighboring Blocks Coded in Inter Mode.

In this variant, the block to encode/decode is intra-predicted, while the one or more blocks that are used for determining the non-available reference samples of the block are inter-coded.

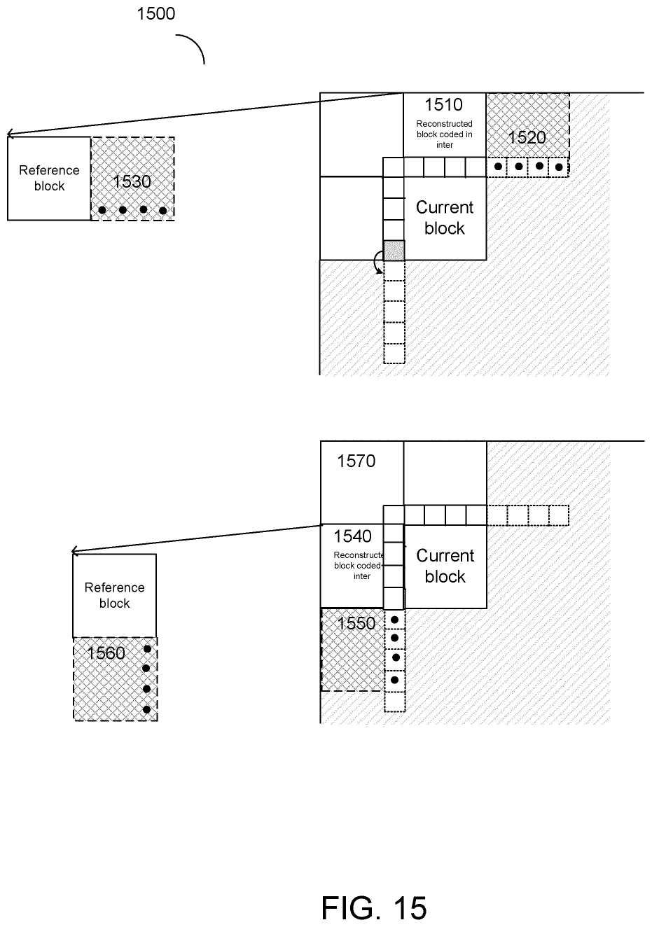

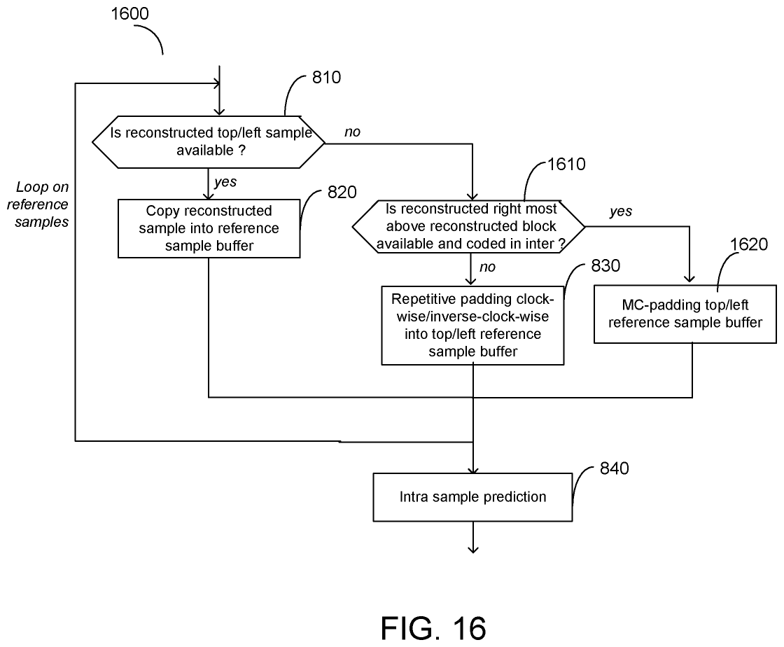

The MC-padding process is used here for filling missing reference samples used for intra prediction. This variant is illustrated on FIGS. 15 and 16, where in FIG. 15 the dashed area corresponds to the region of the picture not yet reconstructed and the missing reference samples are shown in dotted-line.

Let's consider a current block that is to be coded or decoded using an intra prediction, and denote (1510) the right most reconstructed block above the current block that is coded in inter prediction mode. One builds a virtual block (1520) with data obtained from motion compensation of the right extension (1530) of the reference block that is used for predicting the above block (1510). In case of bi-prediction, the virtual block is built with data obtained from motion compensation and blending of the right extension of the two reference blocks that are used for predicting the above block (1510). The bottom samples of the virtual block (1520) are then used to fill-in the missing reference samples to be used for intra prediction of the current block.

Similarly, the same method can be used for the missing reference samples at the bottom left (1550), if the left block (1540) reconstructed at the left of the current block is coded in inter. In this case, the virtual reference block extension (1560) will be situated below the reference block used for predicting the left block (1540).

A virtual block (1550) is built with data obtained from motion compensation of the bottom extension (1560) of the reference block used for predicting the left block (1540). The right samples of the virtual block (1550) are then used to fill-in the missing reference samples to be used for intra prediction of the current block. The two examples of FIG. 15 can be combined when both the top-right and bottom left blocks are not available and their corresponding right or top neighboring block is inter-coded.

In a similar manner, when the top and or left block is not available, the missing reference samples of the top and/or left block can be determined with the same process if the corner block (1570) is coded in inter. The virtual reference block extension will be situated on the right and or below the reference block of the corner block. In a variant, the virtual reference block extension can be further extended to on the right and/or below the reference block of the corner block if the above-right block and/or the bottom left block of the current block are neither available.

The reference sample substitution process of FIG. 8 is modified according to one of the variant described here as illustrated in FIG. 16 (1600). At 810, it is determined whether the above-right, respectively bottom left, reference samples are available or not. In other words, it is determined whether the above-right block, respectively the bottom-left block, of the current block is yet reconstructed or if its reconstructed samples can used for predicting the current block. If it is determined that the above-right, respectively bottom-left, reference samples are available, then at 820, the reconstructed above-right, respectively left, reference samples are copied into the reference sample buffer. Otherwise, at 1610, it is determined whether the left neighbor block of the above-right block, respectively the top neighbor block of the bottom-left block, is a reconstructed block that is available and coded in inter. If the response is no, then at 830, repetitive padding is performed to fill the reference samples from the above-right block, respectively bottom-left. Otherwise, at 1620, motion-compensation (MC) padding is used to fill the reference samples into the refence sample buffer coming from the above-right block, respectively bottom-left.

Then, at 840, the current block is predicted using intra-prediction using the filled reference samples buffer.

In a variant, a flag can be encoded to signal whether repetitive padding or MC-padding is used for reference sample substitution. The flag can be coded per region (group of CUs, slice or picture) or per CU, possibly conditioned with another parameter (e.g. CU size, etc. . . . ) or derived implicitly from other coded or reconstructed parameters. For example, the flag is implicitly set to true when the current block size is inferior to a given value. In another example, the implicit flag value depends on the intra direction used for the current block.

In another variant, to avoid discontinuity between the available (reconstructed) reference samples and the filled (missing) reference samples, an offset may be added to the substituted reference samples. The offset is determined as a difference between the last available reference sample (i.e. the reference sample from the reconstructed block coded in inter that is closest to the missing reference samples) and the first substituted reference sample. Indeed, the available (reconstructed) reference samples are made of inter prediction plus residuals, whereas the substituted reference samples are made of inter prediction only (no residuals).

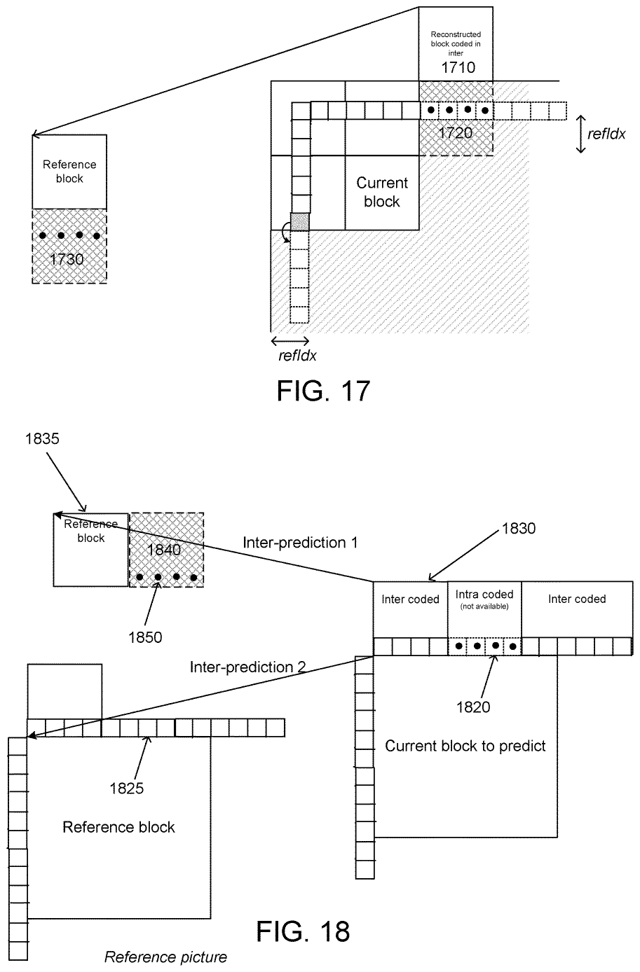

FIG. 17 depicts another example where “mrlIdx” is non-zero. In this case, advantageously, the building of the virtual block (1720) may be made with motion compensation of an extension (1730) of the reference block used for predicting a reconstructed block (1710) spatially close to the missing reference samples. In the example of FIG. 17, the virtual reference block extension (1730) is situated below the reference block.

The selection of the reconstructed block coded in inter and motion parameters that are used to derive the samples for filling the missing reference samples can be derived according to different rules. It can be the block that is closest to the sample to substitute, or it can follow a given rule, e.g.: always using the top left-most reconstructed block coded in inter for filling top right missing samples. The given rule can also depends on a priority order for checking the neighbor blocks of the blocks having missing samples and the coding mode of the neighbor blocks. For instance, if the missing samples are in the above-right block, first check the top left-most reconstructed block and use this block if it is coded in inter for filling top right missing samples, otherwise, check the block that is above the above-right block and use this block if it is coded in inter for filling the missing samples, otherwise use repetitive padding for filling the missing samples.

Thus, the rule for selecting the reconstructed block that is used for MC-padding can be based on at least one of a spatial distance of the missing reference samples to reconstructed block, or on a coding mode of the reconstructed block, or on a location of the reconstructed block with respect to the current block or to the missing reference samples.

Reference Sample Substitution for Inter Prediction with Neighboring Blocks Coded in Inter Mode.

There exist other coding modes where the block prediction mode is based on reconstructed reference samples situated in the neighboring template, and which imposes some restrictions that make some reference samples unavailable. For these unavailable reference samples, a similar process as described above can be used for replacing missing reference samples in place of the regular reference sample substitution method. Variants of such an embodiment are depicted in FIG. 18, as follows.

Some reference samples (1820) are unavailable for a current block to predict, for instance because the reference samples belong to a block that is intra-coded and cannot be used for the inter-prediction of the current block (for instance for predicting the LIC parameters for the current bloc), or the block having the unavailable reference samples (1820) is not yet reconstructed.

If some reference samples are unavailable (1820) for the current block to predict, one looks to the closer reconstructed samples from the block (1830) that neighbors the block having the unavailable reference samples (1820) and that is coded in inter mode. Then the reference block (1835) of this neighboring block (1830) is identified using same motion parameters (inter-prediction 1) as for reconstructing the neighboring block (1830) and extended (1840) so that the motion-compensated (MC) samples (1850) can be used to substitute the unavailable reference samples (1820).

In a variant, if the current block is coded in inter, the motion parameters of the current block can be used (inter-prediction 2) to identify the reference block of the current block and extend this reference block for filling the unavailable reference samples. In this case, the reference block which is extended is the one of the current block. In FIG. 18, reference samples (1825) on top of the reference block of the current block to predict are used to fill the unavailable reference samples (1820).

Reference Sample Substitution for Intra Prediction with Neighboring Blocks Coded in Intra Mode.

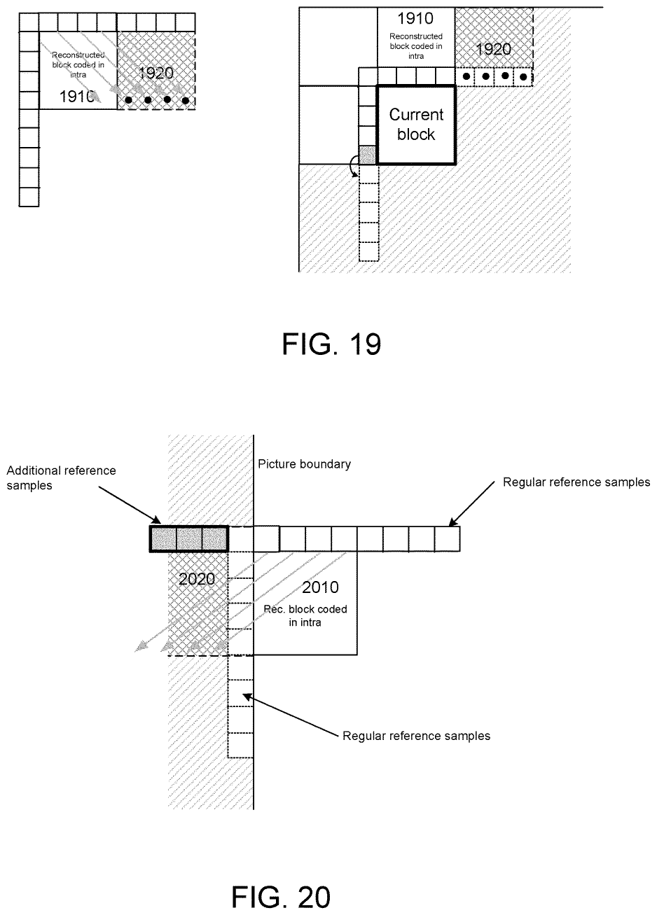

In an embodiment, similarly to the embodiments described above, a similar mechanism can be used for filling missing reference samples used for intra prediction, in the case where the reconstructed neighboring block have been coded in intra. This embodiment is depicted with an example in FIG. 19, where the dashed area corresponds to the region of the picture not yet reconstructed and the missing reference samples are in dotted-line. In this example, the right-most above reconstructed block (1910) has been coded in intra, with intra direction depicted with grey arrows on the left of the figure.

In this embodiment, one builds a virtual block (1920) as the intra prediction of the right extension of the above block (1910). The bottom samples of the virtual block (1920) are used to fill-in the missing reference samples to be used for intra prediction of the current block. Similarly, the same method can be used for the missing reference samples at the bottom left of the current block, if the block reconstructed at the left of the current block is coded in intra.

In this case, the virtual reference block extension (1920) will be situated below the reconstructed left block.

In some variants, the intra-padding described above can be conditioned to some subset of intra directions, else regular padding is used. For example, it is determined whether the intra prediction direction of the right-most above reconstructed block (1910) or of the left block is among a given set of intra prediction modes. If this is the case, the missing reference samples are filled with data obtained using the same intra prediction direction as the right-most above reconstructed block (1910) or left block. Otherwise, regular padding is used.

Intra-Padding for Picture Padding with Neighboring Blocks Coded in Intra Mode.

In an embodiment, the repetitive padding applied at picture boundary is replaced with an intra-padding when the reconstructed boundary block (2010) is intra coded as depicted in the example of FIG. 20. The intra prediction direction used to reconstruct the intra block (2010) is used to fill-in the padded samples in the block extension (2020) using intra prediction process. Additional reference samples can be used, and the missing reference samples can be filled with the regular method (e.g. repetitive padding).

### Estimating Reference Samples Closer to the Current Block for Intra Coding Mode

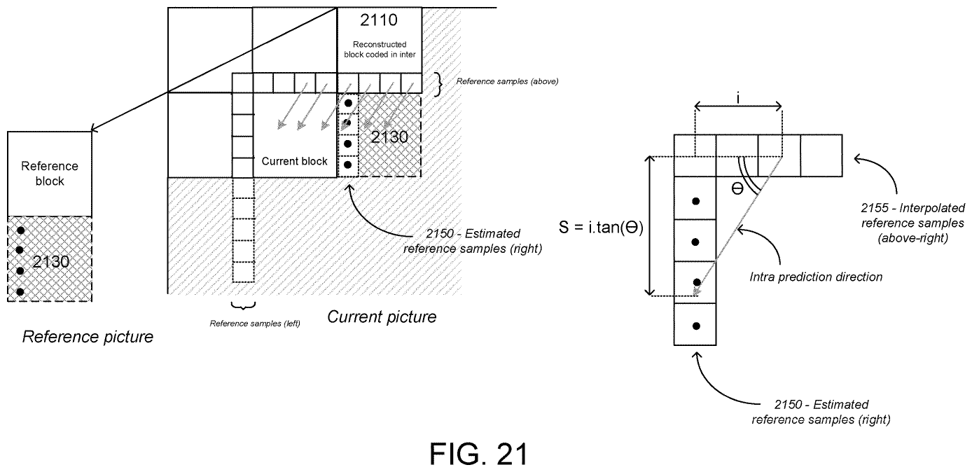

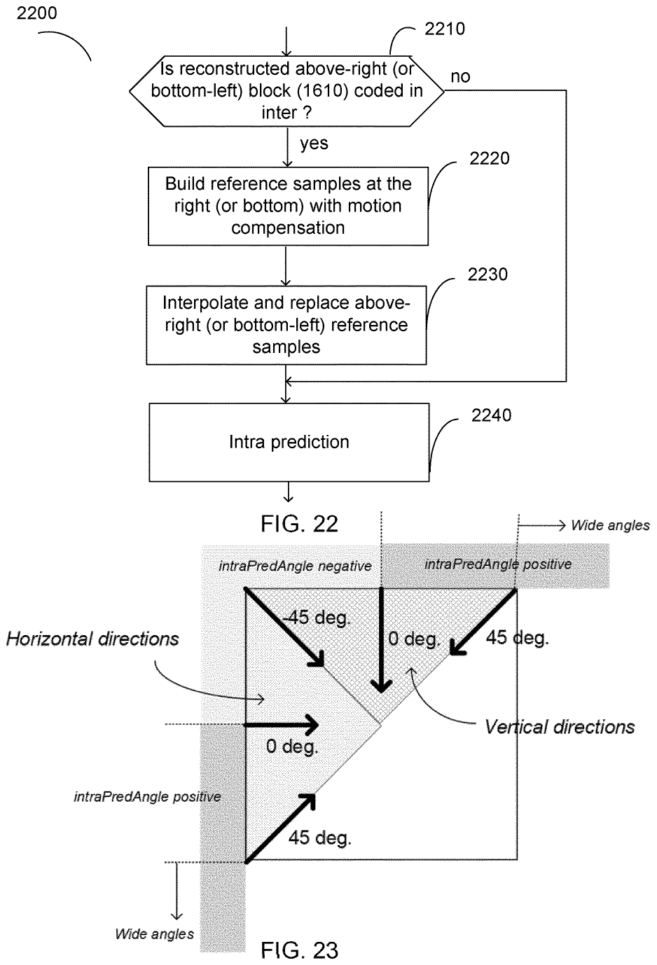

In another embodiment, the above-right (or bottom-left) reference samples used for intra prediction are replaced with estimated reference samples (2150) located nearby the right or bottom edge of the current block as illustrated on FIG. 21 and described in reference with FIG. 22 showing a method 2200 for intra prediction according to an embodiment. At 2210, it is determined whether the reconstructed samples located above-right (or bottom-left) have been coded in inter mode (2110), then, at 2220, the motion information (motion vectors and reference indexes) is used to build the estimated reference samples (2150). The reference block used to reconstruct the samples located above-right (or bottom-left) is identified with the motion information and extended below (2130) (or on the left depending on the location of the samples to estimate with respect to the current block). Next, at 2230, the estimated reference samples (2150) are back-projected into the location of the regular above-right (or bottom-left) reference samples (2155) with interpolation using the intra prediction direction e, as depicted on the right of FIG. 21. For example, at 2230, if the estimated reference samples belong to the block 2130 located on the right of the current block, reference samples located on a first column of the block 2130 located on the right of the current block are back-projected on a last row of the block 2110 located above-right of the current block, using the intra prediction direction e. In another example, if the estimated reference samples belong to the block located at the bottom of the current block, reference samples located on a first row of the block located at the bottom of the current block are back-projected on a last column of the block located bottom-left of the current block, using the intra prediction direction e.

At 2240, intra prediction is done using the estimated reference samples using the regular intra prediction directions.

In another variant, the estimated reference samples are used directly without back-propagation and interpolation, but the intra prediction process is modified as follows.

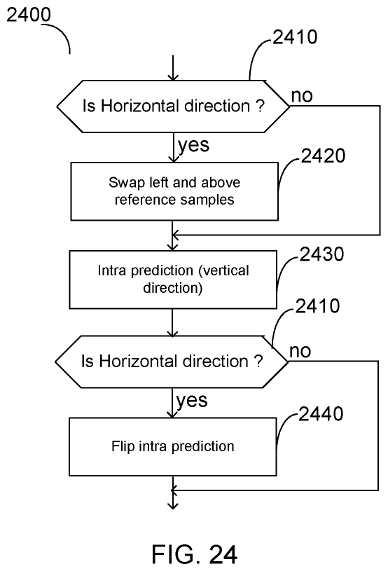

In the regular intra prediction process (such as in HEVC or VVC), in case of horizontal directions, the left and above reference samples are swapped and the intra prediction is applied as with vertical direction as depicted in FIG. 24 showing an example of a method 2400 for intra prediction. At 2410, it is determined whether intra prediction is to be performed with an input horizontal intra prediction direction. If this is the case, at 2420, left and above reference samples are swapped. Intra prediction is then performed at 2430 using an intra prediction direction which is either an input vertical intra prediction direction or a vertical intra prediction direction corresponding to the input horizontal intra prediction direction. If the input intra prediction direction is horizontal (2410), then at 2440, the intra prediction is flipped, that is the prediction obtained from intra prediction performed at 2430 is mirrored with respect to the diagonal of the current block.

FIG. 23 illustrates examples of intra prediction directions and the ranges of the directions that are considered as horizontal intra prediction directions and vertical intra prediction directions.

In this variant, the estimated (right and/or bottom) reference samples can be swapped with regular left and/or above reference samples, and/or flipped, so that the estimated reference samples are situated at the left and above the current block and that regular intra prediction is performed using the estimated reference samples. At last, the predicted samples are flipped to their original position.

The above variant can replace the regular intra prediction mode process or can be an additional intra prediction mode. In this variant, the modified intra prediction process or additional intra prediction mode allows to perform intra prediction for the current block based on estimated reference samples located on the right and at the bottom of the current block.

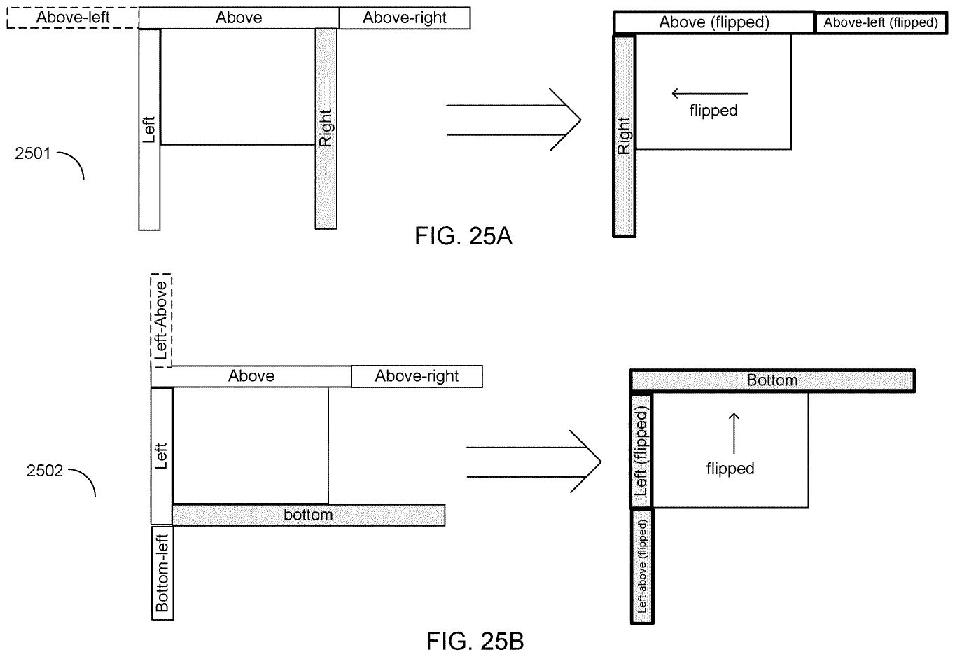

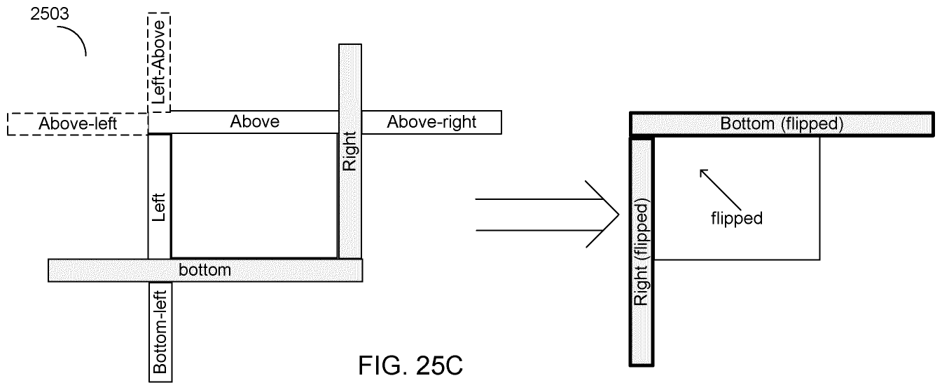

For example, if the intra prediction direction angle θ is positive (e.g. θ=45°) in vertical direction (FIG. 23) for example, the estimated reference samples (2150) in the right are copied into the left reference samples buffer and the above samples (and eventually above-left samples) are flipped into the top reference samples buffer. Next the regular intra prediction process is carried out with intra prediction direction angle equal to θ−90° (−45° in the example) in vertical direction. Finally, the predicted samples are flipped horizontally, as depicted in 2501 in FIG. 25A.

In another variant illustrated in 2502 on FIG. 25B, the estimated reference samples (2150) in the bottom are copied into the above and above right reference samples buffer and the left samples are flipped into the left reference samples buffer. Eventually, the left above reference samples are flipped into the bottom left reference samples buffer. Next the regular intra prediction process is carried out with intra prediction direction angle equal to θ−90°. Finally, the predicted samples are flipped vertically. In a variant, this variant is applied if the intra prediction direction angle θ is positive (e.g. θ=45°) in horizontal direction.

In another variant illustrated in 2503 on FIG. 25C, the estimated reference samples (2150) in the bottom are copied into the above and above right reference samples buffer and flipped and the right samples are flipped into the left and bottom left reference samples buffer. Next the regular intra prediction process is carried out with intra prediction direction angle equal to θ−90°. Finally, the predicted samples are flipped diagonally. In a variant, this variant is applied if an additional flag is signaled and/or if the intra prediction direction angle θ is negative (e.g. θ=−45°).

These variants can also be extended to a general case for intra-prediction with mrlIdx>=0. In these variants, then the example 2501 is extended to the following example wherein reference samples in a column of a block located on a left of the current block are filled with estimated reference samples located in a corresponding column of the block located on the right of the current block, reference samples in a row of a block located above the current block are flipped, and reference samples in a row of a block located above-right the current block are filled with flipped reference samples from a corresponding row of a block located above-left the current block. A corresponding row or column is a row or column that is at a same distance as the row or column given by the mrlIdx.

The example 2502 is extended to the following example wherein reference samples in a row of a block located above of the current block are filled with estimated reference samples located a corresponding row of the block located at the bottom of the current block, reference samples in a column of a block located on the left of the current block are flipped and reference samples in a column of a block located bottom-left of the current block are filled with flipped reference samples from a corresponding column of a block located above-left the current block.

The example 2503 is extended to the following example wherein reference samples in a row of a block located above the current block and reference samples in a corresponding row of a block located above-right the current block are filled with flipped estimated reference samples located in a corresponding row of the block located at the bottom of the current block and flipped reference samples located in a corresponding row of the block located at the bottom-left of the current block, and reference samples in a column of a block located on the left of the current block and reference samples in a column of a block located bottom-left of the current block are filled with flipped estimated reference samples located in a corresponding column of the block located on the right of the current block and flipped reference samples located in a corresponding column of the block located above-right of the current block.

In another embodiment, an indicator (e.g. a flag) is coded in the bitstream to indicate whether any one of the variants described herein in the embodiments estimating the reference samples is used or if the regular intra prediction is used. In a variant, the indicator is coded only if a variant can be applied. For example, if at least one of the above-right or bottom-left blocks is coded in inter mode, then the indicator is coded, whilst if the above-right and bottom-left blocks are coded in intra mode, the indicator is not coded. In another variant, if both the above-right and bottom-left blocks are coded in inter mode, then an indicator signals whether the regular intra prediction, the swap of the right samples, the swap of the bottom samples or the swap of the right and bottom samples should be applied. In this last case, the method allows addressing intra prediction angles up-to 135 deg.

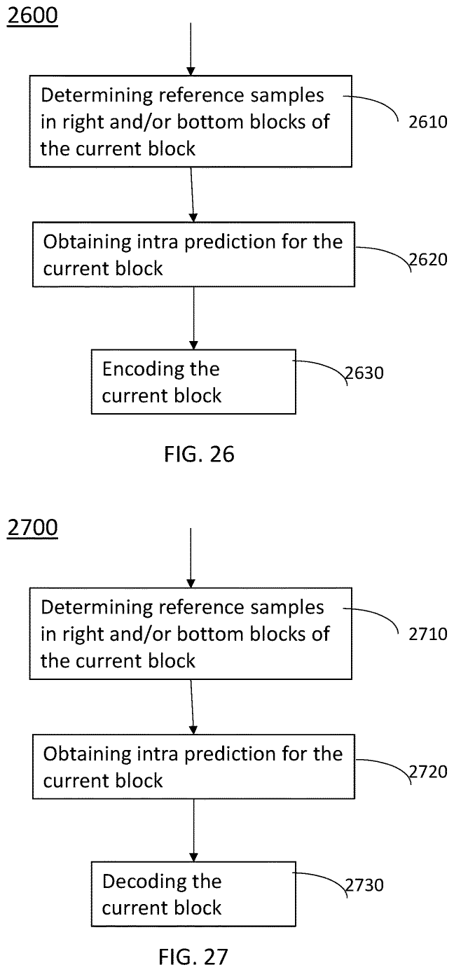

The embodiment described herein can be used in method 2600 for encoding a block of an image or a video according to an embodiment as depicted in FIG. 26. At 2610, one or more reference samples are determined for the block located on the right and/below the block to encode. The reference samples can be determined using any one of the variants described above, for example based on a coding mode of a block neighboring the right block or bottom block. Intra padding or MC-padding as described here can be used depending on the coding mode of the neighbor block.

Once the one or more reference samples have been determined, at 2620, an intra prediction is obtained for the block to encode using the one or more reference samples determined at 2610, and at 2630, the block is encoded using the intra prediction. At 2620, intra-prediction can be performed using an additional intra prediction direction, for example intra prediction directions illustrated on FIG. 23 mirrored with respect to the bottom-left to top-right diagonal. In another example, at 2620, the intra prediction is performed using regular intra prediction directions but with swapping and flipping of the right and bottom buffers as described with FIG. 25A, 25B or 25C for example. The intra prediction is then flipped depending on the intra prediction direction.

FIG. 27 illustrates an example of a method 2700 for decoding a block of an image or a video according to an embodiment. The method 2700 for decoding a block implements a same intra prediction embodiment as the one described with the encoding method 2600. At 2710, one or more reference samples are determined in a similar manner as in 2610 of FIG. 26. Once the one or more reference samples have been determined, at 2720, intra prediction is obtained for the block to decode using the one or more reference samples as in 2620, and at 2730, the block is reconstructed using the intra prediction.

In the embodiments described above, intra prediction can thus be performed using reference samples determined for a non-causal area of the block to encode/decode.

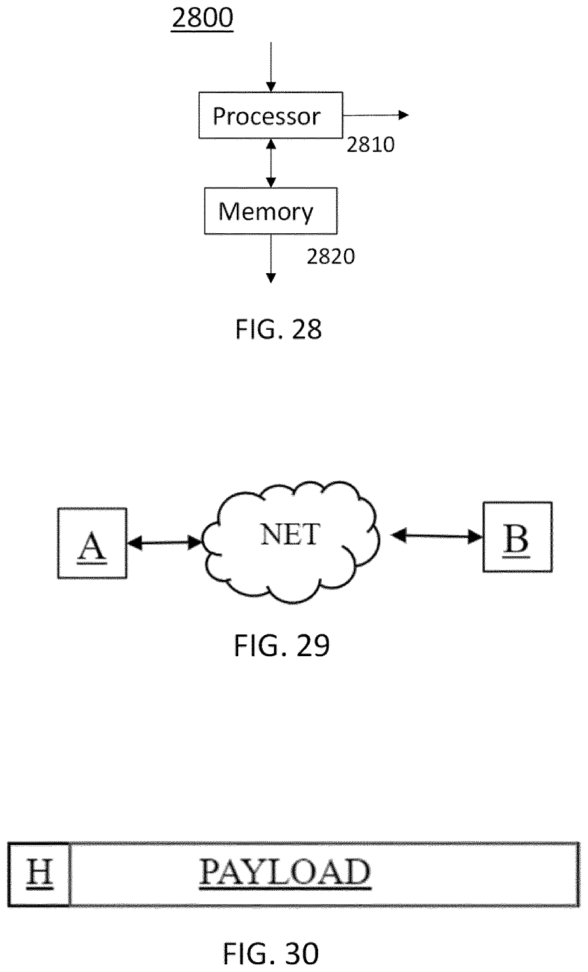

FIG. 28 illustrates a block diagram of a system within which aspects of the present embodiments may be implemented, according to another embodiment. FIG. 28 shows one embodiment of an apparatus 2800 for encoding or decoding an image or a video according to any one of the embodiments described herein. The apparatus comprises Processor 2810 and can be interconnected to a memory 2820 through at least one port. Both Processor 2810 and memory 2820 can also have one or more additional interconnections to external connections. Processor 2820 is also configured to determine at least one reference sample for at least one first block of an image, based on a coding mode used for reconstructing at least one second block of the image, the at least one reference sample being located outside of the at least one second block, obtain a prediction for the at least one first block using the at least one reference sample, and encode the at least one first block based on the prediction, using any one of the embodiments described herein. For instance, the processor 2820 is configured using a computer program product comprising code instructions that implements any one of embodiments described herein.

In another embodiment, processor 2820 is also configured to determine at least one reference sample for at least one first block of an image, based on a coding mode used for reconstructing at least one second block of the image, the at least one reference sample being located outside of the at least one second block, obtain a prediction for the at least one first block using the at least one reference sample, and decoding the at least one first block based on the prediction, using any one of the embodiments described herein. For instance, the processor 2820 is configured using a computer program product comprising code instructions that implements any one of embodiments described herein.

In an embodiment, illustrated in FIG. 28, in a transmission context between two remote devices A and B over a communication network NET, the device A comprises a processor in relation with memory RAM and ROM which are configured to implement a method for encoding an image or a video, as described with FIG. 1-27 and the device B comprises a processor in relation with memory RAM and ROM which are configured to implement a method for decoding an image or a video as described in relation with FIG. 1-27. In accordance with an example, the network is a broadcast network, adapted to broadcast/transmit encoded image or video from device A to decoding devices including the device B.

FIG. 30 shows an example of the syntax of a signal or bitstream transmitted over a packet-based transmission protocol. Each transmitted packet P comprises a header H and a payload PAYLOAD. In some embodiments, the payload PAYLOAD may comprise image or video data according to any one of the embodiments described above. In a variant, the signal or bitstream comprises data representative of any one of the following items:
an indicator indicating whether or not determining missing reference samples for a first block is based on a coding mode used for reconstructing a second block,
an indicator indicating whether repetitive padding or MC-padding is used for reference sample substitution,
an indicator indicating whether any one of the variants described herein in the embodiments for estimating the reference samples is used or if regular intra prediction is used,
an indicator indicating additional intra prediction directions using right and/or bottom block of a first block to encode/decode can be used,
an indicator indicating whether reference samples of a given block neighboring the first block are swapped.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, entropy decoding a sequence of binary symbols to reconstruct image or video data.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:

a. SDP (session description protocol), a format for describing multimedia communication sessions for the purposes of session announcement and session invitation, for example as described in RFCs and used in conjunction with RTP (Real-time Transport Protocol) transmission.

b. DASH MPD (Media Presentation Description) Descriptors, for example as used in DASH and transmitted over HTTP, a Descriptor is associated to a Representation or collection of Representations to provide additional characteristic to the content Representation.

c. RTP header extensions, for example as used during RTP streaming.

d. ISO Base Media File Format, for example as used in OMAF and using boxes which are object-oriented building blocks defined by a unique type identifier and length also known as ‘atoms’ in some specifications.

e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device.

Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information.

Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

1. A method, comprising:
determining at least one reference sample for at least one first block of an image, based on a coding mode derived from at least one second block previously reconstructed of the image, the at least one reference sample being located in the image outside of the at least one second block,
obtaining a prediction for the at least one first block using the at least one reference sample, and
decoding the at least one first block based on the prediction.

2. An apparatus, comprising one or more processors, wherein the one or more processors is operable to:
determine at least one reference sample for at least one first block of an image, based on a coding mode derived from at least one second block previously reconstructed of the image, the at least one reference sample being located in the image outside of the at least one second block,
obtain a prediction for the at least one first block using the at least one reference sample, and
decode the at least one first block based on the prediction.

3. A method, comprising:
determining at least one reference sample for at least one first block of an image, based on a coding mode derived from at least one second block previously reconstructed of the image, the at least one reference sample being located in the image outside of the at least one second block,
obtaining a prediction for the at least one first block using the at least one reference sample, and
encoding the at least one first block based on the prediction.

4. An apparatus, comprising one or more processors, wherein the one or more processors is operable to:
determine at least one reference sample for at least one first block of an image, based on a coding mode derived from at least one second block previously reconstructed of the image, the at least one reference sample being located in the image outside of the at least one second block,
obtain a prediction for the at least one first block using the at least one reference sample, and
encode the at least one first block based on the prediction.

5. The method of claim 1, wherein the at least one reference sample belongs to a non-reconstructed block or to a block having a coding mode that is not allowed for determining a prediction for the at least one first block using the at least one reference sample.

6. The method of claim 1, wherein the at least one reference sample belongs to a block neighboring the at least one second block.

7. The method of claim 1, wherein the coding mode is an intra prediction mode.

8. The method of claim 7, wherein determining the at least one reference sample based on the coding mode derived from the at least one second block previously reconstructed of the image includes filling the at least one reference sample with data obtained using a same intra prediction mode as the at least one second block.

9. The method of claim 7, wherein determining at least one reference sample for at least one first block of an image, based on a coding mode derived from the at least one second block previously reconstructed of the image comprises:
responsive to a determination that a direction of the intra prediction mode is among a first set of intra prediction directions, the at least one reference sample for at least one first block is filled with data obtained using a same intra prediction mode as the at least one second block,
otherwise the at least one reference sample for at least one first block is filled using repetitive padding.

10. The method of claim 1, wherein the coding mode is an inter prediction mode.

11. The method of claim 10, wherein determining the at least one reference sample based on the coding mode derived from the at least one second block of the image includes filling the at least one reference sample with motion-compensated data obtained using motion information of the at least one second block.

12. The method claim 7, wherein determining the at least one reference sample based on the coding mode derived from the at least one second block of the image includes adding an offset to a filled at least one reference sample, the offset being determined from at least one sample of the at least one second block and at least one sample of the filled at least one reference sample.

13. The method claim 1, further comprising selecting the at least one second block among a plurality of blocks based on at least one selection rule, the at least one selection rule being based at least on one of a spatial distance of the at least one reference sample to the at least one second block, or on a coding mode of the at least one second block, or on a location of the at least one second block.

14. The method of claim 1, wherein the prediction for the at least one first block is obtained using an intra prediction.

15. (canceled)

16. The method of claim 1, wherein the prediction for the at least one first block is obtained using an inter prediction and the at least one reference sample is used for determining correction parameters used in the obtaining of the prediction.

17-28. (canceled)

29. A non-transitory computer readable medium storing executable program instructions to cause a computer executing the program instructions to perform a method according to claim 1.

30-33. (canceled)

34. The apparatus of claim 2, wherein the coding mode is an intra prediction mode.

35. The apparatus of claim 34, wherein determining the at least one reference sample based on the coding mode derived from the at least one second block previously reconstructed of the image includes filling the at least one reference sample with data obtained using a same intra prediction mode as the at least one second block.

36. The apparatus of claim 2, wherein the coding mode is an inter prediction mode.

37. The apparatus of claim 2, wherein the prediction for the at least one first block is obtained using an intra prediction.
